(19) United States
(12) Patent Application Publication
(10) Pub. No.: US 2013/0065040 A1
(43) Pub. Date: Mar. 14, 2013

(54) PREPARATIONS FOR PRODUCING REINFORCING FIBERS FOR USE IN CONCRETE UTILIZING POLYCHLOROPRENE DISPERSIONS

(71) Applicants: Rüdiger Musch, Bergisch-Gladbach (DE); Horst Stepanski, Leverkusen (DE); Klaus Dilger, Braunschweig (DE); Stefan Böhm, Schwulper (DE); Frank Mund, Stade (DE)

(72) Inventors: Rüdiger Musch, Bergisch-Gladbach (DE); Horst Stepanski, Leverkusen (DE); Klaus Dilger, Braunschweig (DE); Stefan Böhm, Schwulper (DE); Frank Mund, Stade (DE)

(73) Assignee: Bayer Intellectual Property GmbH, Monheim (DE)

(21) Appl. No.: 13/493,588

(22) Filed: Jun. 11, 2012

Related U.S. Application Data
(63) Continuation-in-part of application No. 11/732,176, filed on Apr. 3, 2007.
Application No. 11/732,176 is a continuation-in-part of application No. 11/257,188, filed on Oct. 24, 2005, now abandoned.

(30) Foreign Application Priority Data
Oct. 27, 2004 (DE) 10 2004 052 170.0
Apr. 6, 2006 (DE) 10 2006 016 608.6

(51) Int. Cl. B32B 13/02; C08L 27/04; C08L 33/08; C08L 67/00; C08L 75/02; C08L 63/00; C08L 21/00; C08K 3/36; C08K 3/22; D02G 3/36; C08L 75/04; B82Y 30/00

(52) U.S. Cl. 428/294.7; 428/375; 524/552; 524/519; 524/502; 524/507; 523/438; 524/493; 524/432; 977/773

(57) ABSTRACT

The invention provides the use of mixtures based on aqueous dispersions of polychloroprene to produce fiber products finished therewith, a process for the production thereof and the use of these finished fiber products to produce textile-reinforced and fiber-reinforced concrete and other products based on cement.

### CROSS-REFERENCE TO RELATED APPLICATIONS

The present application claims the right of priority under 35 U.S.C. §119 (a)-(d) of German Patent Application Number DE102006016608, filed Apr. 6, 2006.

### BACKGROUND OF THE INVENTION

The invention provides the use of mixtures based on aqueous dispersions of polychloroprene to produce fiber products finished therewith, a process for the production thereof and the use of these finished fiber products to produce textile-reinforced and fiber-reinforced concrete and other products based on cement.

Concrete is one of the most important materials used in the construction industry and offers many advantages. It is inexpensive, durable and flexible with regard to design and production technique. The fields of application are correspondingly varied and cover both the static-constructive area and the non-load-bearing area.

For the transfer of compression forces, textile-reinforced concrete offers a particularly beneficial cost-to-performance ratio and is therefore used to a large extent in the construction industry. For example, economical absorption of pressure by the concrete, targeted reinforcement by long fibers, the ability to make thin-walled concrete members that are fire resistant and corrosion insensitive.

Due to the low tensile strength of concrete, reinforcement is required in order to absorb tensile forces. Reinforcement usually consists of steel. In order to ensure bonding and to protect from corrosion, steel reinforcement of concrete is generally provided with a concrete covering that is at least 2-3 cm thick. This means that components are at least 4-6 cm thick, depending on the environmental stresses and the method of production. If corrosion-insensitive, non-metallic materials are used as reinforcement materials, then thinner concrete covering can be used and filigreed and thin-walled cross-sections can be produced.

Short fibers are primarily used to strengthen thin-walled concrete parts. Currently, the position and orientation of the short fibers in the composite material do not have to be clearly defined. The field of application of modern concretes strengthened with short fibers is therefore restricted substantially to components that are subject to low mechanical stress such as, for example, flooring screeds and objects such as plant pots, etc.

Long fibers, for example, in the form of rovings or textiles, exhibit greater effectiveness in thin-walled concrete components, and these may be arranged in the direction of the tensile stresses that occur.

In order to develop more demanding, and also new types of, fields of application for fiber-concrete methods of construction, engineering textiles with reinforcement filaments in the direction of greatest tensile stress are provided. Engineering textiles (two-dimensional or multi-dimensional) such as non-wovens, nets, knitted fabrics or contoured knitted fabrics can currently be used only in individual cases for the industrial production of textile-reinforced concrete components. The reason for this is the current lack of production processes for working with such textiles to give components with complicated geometries. Present methods for the production of textile-reinforced components permit only linear flat shapes because in most cases dimensional stability of the textile is achieved by tension. Particularly in the case of complicated geometries, the application of tension during industrial production is impossible or possible to only a limited extent. At the moment it is not possible to insert flexible reinforcement textiles into such components in a reproducible manner.

Currently, steel, plastic or glass fibers are used to reinforce cement-bonded building materials. The plastic fibers are mostly polypropylene fibers, but aramide fibers, are also utilized. Table 1 gives typical mechanical parameters of various fibers.

TABLE 1
Properties of possible reinforcement fibers

| | | Tensile | |
|---|---|---|---|
| | Density | strength | E-modulus |
| Material | [g/cm³] | [GPa] | [GPa] |
| Alkali-resistant AR-glass | 2.5-2.7 | 1.7-2.0 | 74 |
| Carbon | 1.6-2.0 | 1.5-3.5 | 180-500 |
| Aramide | 1.44-1.45 | 2.8-2.9 | 59-127 |
| Polypropylene | 1.0 | 0.5-0.75 | 5-18 |

Among the large group of different glasses, so-called AR-glass fibers are the only ones suitable because only they have a sufficiently high resistance in the highly alkaline surroundings of cement-bonded building materials.

In the paper “USE OF ADHESIVES FOR TEXTILE-REINFORCED CONCRETE”, by S. Bohm, K. Dilger and F. Mund, presented at the 26^{th} Annual Meeting of the Adhesive Society in Myrtle Beach, S.C., USA, Feb. 26, 2003, it was shown that the theoretical value for yarn tensile strength/load-carrying capacity of reinforcement textiles in concrete is not achieved. The yarn tensile tests described in this publication showed that the yarn tensile strength can be increased by 30-40% by penetration with a polymeric phase. Such penetration was achieved by soaking strands of fibers (called “ravings”) with various aqueous polymer dispersions, including those based on polychloroprene, and also with reactive resin formulations based on epoxide resin or unsaturated polyesters.

Three methods are known for polymeric coating and soaking of such textile fibers:

Method 1: The first method is based on a 2-step system. The filaments or rovings are first coated or penetrated by a polymeric phase and then embedded in fine concrete. Polymers used for this process are aqueous dispersions based on polychloroprene, acrylate, chlorinated rubber, styrene-butadiene or reactive systems based on epoxide resin and those based on unsaturated polyesters. Penetration of the rovings may take place by coating the filaments during roving production or by soaking the rovings before or after textile production. The polymeric phase is cured or cross-linked before introducing the strengthening textiles into the concrete. Afterwards, the rovings or textiles treated in this way are embedded in fine concrete. In order to be able to make use of the mechanical properties of the fibers, the resin must have expansion properties that are at least as good as those of the fibers.

Method 2: The second method comprises introducing thermoplastic filaments during roving production. These are then melted, they wet the filaments and, after solidification, lead to internal adhesive bonds. However in this case friction spun yarns are not used. Rather, thermoplastic filaments are added during production of the yarn.

Method 3: The third method is based on a 1-step system. In the 1-step system, the textiles are soaked, during the fresh concrete phase, with polymers added to the fine concrete.

Part of the present invention is aimed at improving the properties of the fiber products used for reinforcement and that are finished using method 1. Polychloroprene in the form of a strongly alkaline aqueous dispersion appears to be especially suitable here, due to its known properties, in particular when it is highly crystallizable.

It is known that such a polychloroprene is chemically very stable in alkaline surroundings. Therefore this polymer is highly qualified for use in concrete.

The material-mechanical properties of textile-strengthened concrete depend on the position of the textile reinforcement. It is known that, at room temperature, highly crystalline polychloroprene in the form of aqueous dispersions enables thorough soaking of the fibers. As a result of the crystallinity, the thoroughly soaked textile is so stiffened after drying that it can be introduced into the shuttered form-work rigid, as geometrically fixed reinforcement.

When warmed, the partly crystalline structure can be converted into an amorphous state so that the textile two-dimensional structure can be reshaped to give the three-dimensional shape desired and the textile then remains in this shape in a rigid form after cooling and recrystallization.

The mechanical stresses introduced to the concrete should preferably be distributed uniformly over the entire yarn cross-section of the textile, while avoiding localized stress peaks and should ensure the greatest possible bond between the concrete matrix and the textile when subjected to strain. This object is achieved by the mixture used according to the invention for thorough soaking of the textile. However, the adhesion of concrete to individual fibers should also be improved in order to improve the properties of concrete parts that contain admixed individual fibers for reinforcement purposes, e.g. flooring screeds.

Therefore, modification of the composition of a mixture based on polychloroprene dispersion was required, in such a way that the mechanical properties of concrete parts that are reinforced with fiber products are substantially enhanced.

Fiber products in the context of the present invention are fibers, rovings, yarns, textiles, knitted fabrics, non-wovens or bonded fabrics.

The object of the present invention can be achieved by using an aqueous alkaline dispersion for soaking fiber products used to strengthen concrete that contains, in addition to polychloroprene, additional inorganic solids, preferably from the group of oxides, carboxides and silicates, particularly preferably silicon dioxide, preferably in the form of nanoparticles. The effectiveness of the inorganic solids is increased even more if the polychloroprene contains a particularly high concentration of hydroxyl groups, typically a concentration of 0.1 to 1.5 mol % of hydroxyl groups with respect to the C1-substituents of the polychloroprene is favourable, and a high proportion of gel, i.e. up to 60% by weight of the polychloroprene remains as an insoluble fraction of the polymer part of the dispersion after its dissolution in THF.

The strength properties achieve maximum values when, after soaking, the fiber products are dried at elevated temperatures, generally above 20° C., preferably temperatures above 100° C., particularly preferably up to 220° C., above all when the inorganic solid used is zinc oxide.

### SUMMARY OF THE INVENTION

The present invention therefore provides a process for preparing a concrete-reinforcing fiber comprising soaking the fiber in an aqueous mixture containing
a) a polychloroprene dispersion with an average particle size of 60 to 220 nm, and
b) an aqueous dispersion of inorganic solids, with an average primary particle size of 1 to 400 nm.

### BRIEF DESCRIPTION OF THE DRAWINGS

FIG. 1 is a perspective view of the apparatus utilized in preparing the specimens used in the Examples.

FIG. 2 is a perspective view of the apparatus used to conduct the “pull-out” test in the Examples.

FIG. 3 is an end view of the apparatus of FIG. 2.

FIG. 4 is a schematic view of the apparatus used to conduct the flexural tension test in the Examples.

FIG. 5 is a graphical illustration of the results of the flexural tension test.

### DETAILED DESCRIPTION OF THE PREFERRED EMBODIMENTS

It should be understood that, as used herein and in the claims, the phrase “an aqueous dispersion of inorganic solids” does not include concrete.

The polychloroprene dispersion (a) is obtainable using known methods, preferably by:
polymerization of chloroprene in the presence of 0-1 mmol, with respect to 100 g of monomer of a regulator, at temperatures of 0° C.-70° C., wherein the dispersion contains a proportion of 0-30 wt. %, with respect to the polymer, that is insoluble in organic solvents,
removal of the residual non-polymerized monomers by steam distillation,
storage of the dispersion at temperatures of 50° C.-110° C., wherein the proportion that is insoluble (i.e. the gel fraction) in organic solvents (THF) rises to 0.1 wt. % to 60 wt. %, and increasing the proportion of solids to 50-64 wt. % by a creaming process.

In a preferred embodiment of the invention, following soaking according to the invention of fiber products with the mixture, the mixture is crosslinked on the substrate after removing the water at temperatures of 20° C.-220° C.

The preparation of polychloroprene has been known for a long time. It is accomplished by emulsion polymerization in alkaline aqueous medium; see “Ullmanns Encyclopädie der technischen Chemie”, vol. 9, p. 366, Verlag Urban and Schwarzenberg, Munich-Berlin 1957; “Encyclopedia of Polymer Science and Technology”, vol. 3, p. 705-730, John Wiley, New York 1965; “Methoden der Organischen Chemie” (Houben-Weyl) XIV/1, 738 et seq., Georg Thieme Verlag Stuttgart 1961.

Suitable emulsifiers are all compounds and mixtures thereof that stabilize the emulsion sufficiently, such as e.g. water-soluble salts, in particular sodium, potassium and ammonium salts of long-chain fatty acids, rosin and rosin derivatives, higher molecular weight alcohol sulfates, arylsulfonic acids, form-aldehyde condensates of arylsulfonic acids, non-ionic emulsifiers based on polyethylene oxide and polypropylene oxide as well as emulsifying polymers such as polyvinylalcohol (DE-A 2 307 811, DE-A 2 426 012, DE-A 2 514 666, DE-A 2 527 320, DE-A 2 755 074, DE-A 3 246 748, DE-A 1 271 405, DE-A 1 301 502, U.S. Pat. No. 2,234,215, JP-A 60-31 510).

According to the invention, suitable polychloroprene dispersions are prepared by emulsion polymerization of chloroprene and an ethylenically unsaturated monomer that is copolymerizable with chloroprene, in alkaline medium.

Particularly preferred polychloroprene dispersions are prepared by continuous polymerization such as are described, e.g., in WO-A 2002/24825 (Example 2), and DE 3 002 734 (Example 6), the contents of both of which are hereby incorporated by reference. The regulator content may be varied between 0.01% and 0.3%.

The chain transfer agents required to adjust the viscosity are, e.g., mercaptans.

Particularly preferred chain transfer agents are n-dodecyl mercaptan and the xanthic disulfides used in accordance with DE-A 3 044 811, DE-A 2 306 610 and DE-A 2 156 453.

After polymerization, residual chloroprene monomer is removed by steam distillation. This is performed as described, for example, in “W. Obrecht in Houben-Weyl: Methoden der organischen Chemie,” vol. 20, part 3, Makro-molekulare Stoffe (1987), p. 852.

In a preferred embodiment of the present invention, the low-monomer polychloroprene dispersion prepared in this way is then stored at elevated temperatures. In this way, some of the labile chlorine atoms are eliminated producing OH groups in a concentration of 0.1 to 1.5% and a polychloroprene network that is not soluble in organic solvents (gel) is built up.

In another step, the solids content of the dispersion is preferably increased by means of a creaming process. This creaming process is performed, for example, by adding alginates as described in “Neoprene Latices,” John C. Carl, E.I. Du Pont 1964, p. 13 or EP-A 1 293 516.

Aqueous dispersions of inorganic solids, preferably from the group of oxides, carboxides and silicates, particularly preferably silicon dioxide, are known. They are available in a variety of structures, depending on, the manufacturing process.

Silicon dioxide dispersions that are suitable according to the invention can be obtained on the basis of silica sol, silica gel, pyrogenic silicas or precipitation silicas or mixtures of these.

Aqueous dispersions of inorganic solids that are preferably used according to the invention are those in which the particles have a primary particle size of 1 to 400 nm, preferably 5 to 100 nm and particularly preferably 8 to 50 nm. Preferred mixtures according to the invention are those in which the particles of inorganic solids, e.g. the SiO₂ particles in a silicon dioxide dispersion b), are present as discrete non aggregated primary particles. It is also preferred that the particles have hydroxyl groups available at the surface of the particles (i.e. silanols). Aqueous silica sols are particularly preferably used as aqueous dispersions of inorganic solids. Silicon dioxide dispersions that can be used according to the invention are disclosed in WO2003/102066.

An essential property of the dispersions of inorganic solids used according to the invention is that they do not act as thickeners, or only do so to a negligible extent, upon adding water-soluble salts (electrolytes) or substances that can go partially into solution and increase the electrolyte content of the dispersion, such as e.g. zinc oxide. The thickening effect in formulations of polychloroprene dispersions should not exceed 2000 mPa s, preferably 1000 mPa s. This applies, in particular, to silicas.

The mixture according to the invention has a concentration of non volatile components of 30 to 60 wt. %, wherein the proportion of polychloroprene dispersion (a) amounts to 20 to 99 wt. % and the dispersion of inorganic solids (b) amounts to 1 to 80 wt. %, wherein the percentage data refer to the weight of non-volatile components and add up to 100 wt. %.

Mixtures according to the invention preferably contain a proportion of 70 wt. % to 98 wt. % of a polychloroprene dispersion (a) and a proportion of 2 wt. % to 30 wt. % of a dispersion of inorganic solids (b), wherein the percentage data refer to the weight of non-volatile components and add up to 100 wt. %.

Polychloroprene dispersions (a) as defined to represent the total polymer content may optionally also contain other dispersions, such as e.g. polyacrylate, poly-vinylidenechloride, polybutadiene, polyvinylacetate or styrene-butadiene dispersions or mixtures thereof, in a proportion of up to 30 wt. %, with respect to the entire polychloroprene dispersion (a).

Dispersions (a) and/or (b) or the entire mixture according to the invention may optionally contain further auxiliary substances and additives that are known from adhesive and dispersion technology, e.g., resins, stabilizers, antioxidants, cross-linking agents and crosslinking accelerators. For example, fillers such as quartz flour, quartz sand, barytes, calcium carbonate, chalk, dolomite or talcum, optionally together with wetting, agents, for example polyphosphates, such as sodium hexametaphosphate, naphthalinesulfonic acid, ammonium or sodium polyacrylates may be added, wherein the fillers are added in amounts of 10 to 60 wt. %, preferably 20 to 50 wt. %, and the wetting agents are added in amounts of 0.2 to 0.6 wt. %, all weight percentages being with respect to the non-volatile components.

Other suitable auxiliary agents such as, for example, organic thickeners such as cellulose derivatives, alginates, starches, starch derivatives, polyurethane thickeners or polyacrylic acid may be added to the dispersions (a) and/or (b) or the entire mixture, in amounts of 0.01 to 1 wt. %, with respect to non-volatile components. Inorganic thickeners such as, for example, bentonites, may alternatively be added in amounts of 0.05 to 5 wt. %, with respect to the non-volatile components. The thickening effect in the formulation as a result of the organic or inorganic thickeners should not exceed 2000 mPa s, preferably 1000 mPa s.

For preservation purposes, fungicides may also be added to compositions according to the invention. Those are used in amounts of 0.02 to 1 wt. %, with respect to non-volatile components. Suitable fungicides are, for example, phenol and cresol derivatives or organotin compounds or azol derivatives such as Tebuconazol^{INN} or Ketoconazol^{INN}.

Optionally, tackifying resins such as unmodified or modified natural resins such as rosin esters, hydrocarbon resins or synthetic resins such as phthalate resins may also be added to compositions according to the invention, or to the components used to prepare them, in dispersed form (see e.g. “Klebharze” R. Jordan, R. Hinterwaldner, p. 75-115, Hinterwaldner Verlag Munich 1994): Alkylphenol resin and terpenephenol resin dispersions with softening points higher than 70° C., particularly preferably higher than 110° C., are preferred.

It is also possible to use organic solvents such as, for example, toluene, xylene, butyl acetate, methylethyl ketone, ethyl acetate, dioxan or mixtures of these or plasticizers such as, for example, those based on adipate, phthalate or phosphate, in amounts of 0.5 to 10% by weight with respect to non-volatile components.

Mixtures to be used according to the invention are prepared by mixing the polychloroprene dispersion (a) with, the dispersion of inorganic solids (b) and optionally adding conventional auxiliary substances and additives to the mixture obtained or to both components or to individual components.

Preferably the polychloroprene dispersion (a) is first blended with the auxiliary substances and additives and the dispersion of inorganic solids (b) is added during or after the blending process.

Mixtures according to the invention are applied in known ways, e.g., by painting, casting, spraying or immersing. The film produced can be dried at room temperature or at an elevated temperature up to 220° C.

Mixtures according to the invention may also be used as adhesives, for example, to bond any substrates of identical or different types. The adhesive layer on or in the type of substrate obtained may then be crosslinked. The substrates obtained in this way may optionally be used to strengthen (reinforce) concrete.

Fiber products treated in accordance with the invention are generally advantageous for strengthening or reinforcing concrete. However, they are especially advantageously used to produce those cement-bonded products that are distinguished in that they have to withstand a sudden isolated strain.

Therefore fiber products treated in accordance with the invention are particularly highly suitable for the production of, for example, bullet-resistant facade elements, bunker walls and bunker doors, strong-room walls, armour-plating and armour-plated parts for military vehicles, such as are used for example in gun-turrets, coverings and barriers against rock falls and avalanches, crash-barriers, anti-impact elements, bridges and bridge elements, earthquake-safe buildings or parts of buildings, doors and door elements, in particular safety doors, doors for shelters and bunkers, pylons, in particular overhead cable pylons for the power industry, roofs and roof parts.

These uses and the items obtained for these uses are therefore also a part of the present invention.

### EXAMPLES

### Preparing the Polychloroprene Dispersions

Chloroprene or the polychloroprene dispersion is polymerized in a continuous process as described in EP-A 0 032 977.

### Example 1

Into the first reactor of a polymerization cascade consisting of 7 identical reactors, each with a volume of 50 liters, are introduced the aqueous phase (W) and the monomer phase (M) in a permanently constant ratio, via a measurement and control apparatus, and also the activator phase (A). The mean residence time in each tank is 25 minutes. The reactors are the same as those described in DE-A 2 650 714 (data in parts by wt. per 100 g parts by wt. of monomers used).

(M)=monomer phase:

| | | |
|---|---|---|
| chloroprene | 100.0 | parts by wt. |
| n-dodecyl mercaptan | 0.11 | parts by wt. |
| phenothiazine | 0.005 | parts by wt. |

(W)=aqueous phase:

| | | |
|---|---|---|
| demineralised water | 115.0 | parts by wt. |
| sodium salt of disproportionated abietic acid | 2.6 | parts by wt. |
| potassium hydroxide | 1.0 | parts by wt. |

(A)=activator phase:

| | | |
|---|---|---|
| 1% aqueous formamidinesulfinic acid solution | 0.05 | parts by wt. |
| potassium persulfate | 0.05 | parts by wt. |
| anthraquinone-2-sulfonic acid, Na salt | 0.005 | parts by wt. |

The reaction starts up readily at an internal temperature of 15° C. The heat of polymerization being released is removed and the polymerization temperature is held at 10° C. by an external cooling system. At a monomer conversion of 70%, the reaction is terminated by adding diethylhydroxylamine. The residual monomers are removed from the polymers by steam distillation. The solids content is 33 wt. %, the gel content is 0 wt. % and the pH is 13.

After a polymerization time of 120 hours, the mixture leaves the polymerisation line.

Then the dispersion is creamed according to the following process.

Solid alginate (Manutex) is dissolved in deionised water and a 2 wt. % alginate solution is prepared. 200 g of the polychloroprene dispersion are initially introduced to each of eight 250 ml glass bottles and 6 to 20 g of the alginate solution is stirred, in 2 g steps, into each bottle. After a storage time of 24 hours, the amount of serum being formed above the thick latex is measured. The amount of alginate in the sample with the greatest serum formation is multiplied by 5 and gives the optimum amount of alginate to cream 1 kg of polychloroprene dispersion.

### Example 2

The same procedure as described in Example 1 is followed, but the amount of regulator in the monomer phase is reduced to 0.03 wt. %.

The solids content is 33 wt. % and the gel content is 1.2 wt. %; the pH is 12.9.

After steam distillation, the dispersion is conditioned in an insulated storage tank for 3 days at a temperature of 80° C., wherein the temperature is post-regulated, if required, by a supplementary heating system and the rise in gel content in the latex is measured taking samples.

This dispersion was also creamed in the process described in Example 1.

B) Substances used:

All percentages are given in weight-%

| | | | |
|---|---|---|---|
| Polychloroprene | average particle | | Gel: 0% |
| dispersion from | size*): 90 nm | | Solids: 58% |
| Example 1 | | | pH: 12.9 |
| Polychloroprene | average particle | | Gel: 16% |
| dispersion from | size*): 110 nm | | Solids: 56% |
| Example 2 | | | pH: 12.7 |
| Silicon dioxide | Dispercoll ® | Bayer | Solids: 50% |
| dispersion | S 5005 | Material- | average |
| | | Science AG | primary |
| | | | particle size: |
| | | | 50 nm |
| | | | Surface area: |
| | | | 50 m²/g |
| Acrylate | Plextol ® E 220 | Polymer Latex | Solids: 60% |
| dispersion | average particle | GmbH & Co. KG | pH: 2.2 |
| | size*): 630 nm | | |
| Antioxidant | Rhenofit ® DDA | Rhein Chemie | 50% solids |
| | 50 EM | GmbH | in water |
| Zinc oxide | VP 9802 | Borchers | 50% solids |
| | | GmbH | in water |
| Terpene-phenol | HRJ 11112 | Schenectady | 50% solids |
| resin dispersion | | International, | in water |
| | | Inc. | |

*)determined by the ultra-centrifuge method

### C) Examples:

The following formulations were made up (data in parts by weight):

| Formulation no. | 1 | 2 | 3 | 4 | 5 |
|---|---|---|---|---|---|
| Polychloroprene | 100 | 100 | 100 | — | — |
| dispersion 1 | | | | | |
| Polychloroprene | — | — | — | 100 | 100 |
| dispersion 2 | | | | | |
| Dispercoll ® S 5005 | — | — | 30 | 30 | 30 |
| Plextol ® E 220 | 30 | — | — | — | — |
| Resin HRJ 11112 | — | 30 | — | — | — |
| Rhenofit ® DDA 50 EM | 2 | 2 | 2 | 2 | 2 |
| ZnO Borchers | 4 | 4 | — | — | 4 |

Examples 1 and 2: Comparison; Examples 3 to 5: According to the invention

Alkali-resistant Vetrotex® glass fiber rovings with a thickness of 2400 Tex were soaked with these formulations and then dried in the open in the laboratory, suspended and loaded with weights.

The forces required to “pull-out” specimens prepared in this way from a concrete block were tested. The following procedure was used:

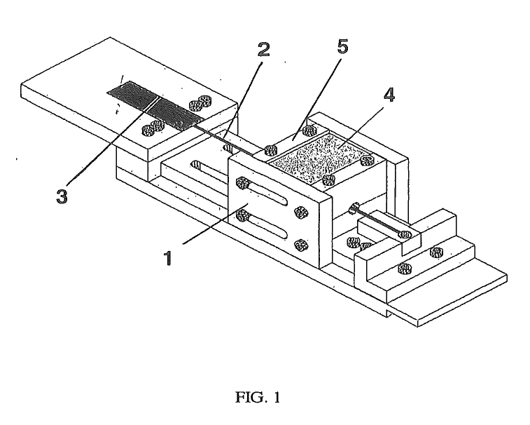

To prepare the specimens for the pull-out test, the mould and formwork 1 shown in FIG. 1 was used: the fiber 2 is clamped in the formwork 3. Thespace for filling with concrete 4 is designed so that the thickness of the pull-out body can be varied by moving a wall 5. All gaps and the feedthrough for the rovings from the formwork are sealed with sealants.

The concrete formulation was prepared as follows:

| | | | |
|---|---|---|---|
| Feedstock | Type | Source | Parts by wt. |

Binder

| | | | |
|---|---|---|---|
| Cement | CEM 1 52.5 | Spenner Zement, | 490 |
| | | Erwitte | |

Additives

| | | | |
|---|---|---|---|
| Fly ash | Safament HKV | Jacob GmbH, | 175 |
| | | Völklingen | |
| Silica dust | EMSAC 500 DOZ | Woermann, Darmstadt | 70 |
| slurry | | | |
| Plasticiser | FM 40 | Sika Addiment, | 10.5 |
| | | Leimen | |

Aggregates

| | | | |
|---|---|---|---|
| Quartz flour | Milisil W3 | Quarzwerke Frechen | 499 |
| Sand | 0.2-0.6 mm | Quarzwerke Frechen | 714 |

Other

| | | | |
|---|---|---|---|
| Water | Tap water | STAWAG, Aachen | 245 |

Mixing instructions:
Weigh out all substances accurately to 0.1 g
1. Homogenize cement, fly ash and aggregates (part mix 1)
2. Place water, silica slurry and 50% of plasticizer in this sequence in mortar mixer (DIN 196-1) (part mix 2)
3. Carefully, add part mix 1 to part mix 2; mix for 1.5 min at low speed setting
4. Wait for 2 min
5. Add remaining plasticiser and mix for a further 1.5 min at low speed setting
—
Note
Strip formwork after 1 day.

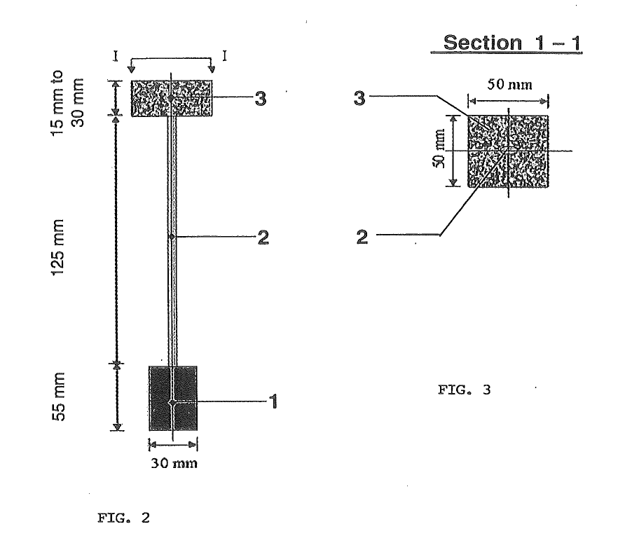

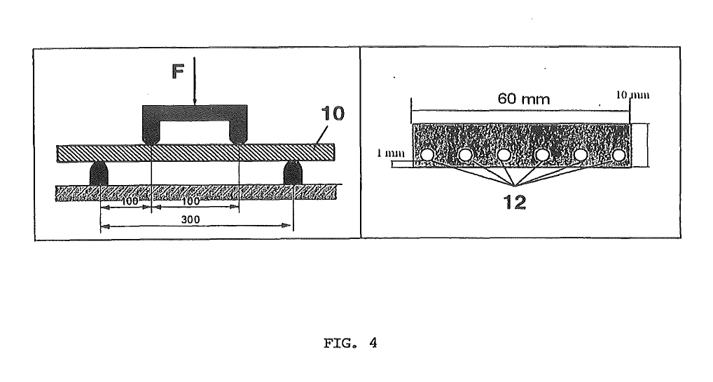

The layout and dimensions of a pull-out specimen and the test set-up are shown in FIGS. 2 and 3.

Sample holder 1 was suspended on a universal joint in order to keep the effects of torque and lateral forces small. A rubber coating smoothed out small irregularities on the surface of the concrete block and thus ensured more uniform distribution of pressure.

The test speed during the tests was 5 mm/min. The rovings 2 were embedded 20 mm inside the concrete.

During the “pull-out” test, the critical force is that at which the rovings 2 become loosened from the concrete matrix 3 and start to slip out.

Force at which the roving begins to slip out of the concrete:

| | Formulation no. | | | | |
|---|---|---|---|---|---|
| | 1 | 2 | 3 (acc. to | 4 (acc. | 5 (acc. |
| | (Comp.) | (Comp.) | invention) | to inv.) | to inv.) |
| Mean value [N] | 75 | 99 | 148 | 177 | 167 |
| Standard deviation [N] | — | 14 | 19 | 29 | 24 |
| Number of samples | 1 | 3 | 5 | 5 | 4 |

To investigate the component properties of textile-reinforced concrete elements, strip-shaped specimens 10 were also prepared. The concrete used was a ready-mixed supply from Durapact GmbH (Haan) with the name “Durapact Matrix”. The reinforcement used comprised 6 alkali-resistant (AR) glass fiber rovings 12 with a thickness of 2400 tex from Vetrotex®, laid in the tensile plane of the specimens 10 with a concrete covering of one mm. The specimens 10 were stored at room temperature and a humidity of about 95% for 28 days after preparation. Before the tests, they were then dried for 2 days at room temperature. The test performed was the 4-point flexural tension test, similar to EN 1170-5, with the following boundary conditions:
Dimensions of the specimens: 325 mm×60 mm×10 mm
Reinforcement: 6 Vetrotex® AR glass rovings 2400 tex positioned in the tensile plane with a one millimeter concrete covering
Test speed: 1 mm/min
Environmental conditions: Laboratory surroundings, room temperature

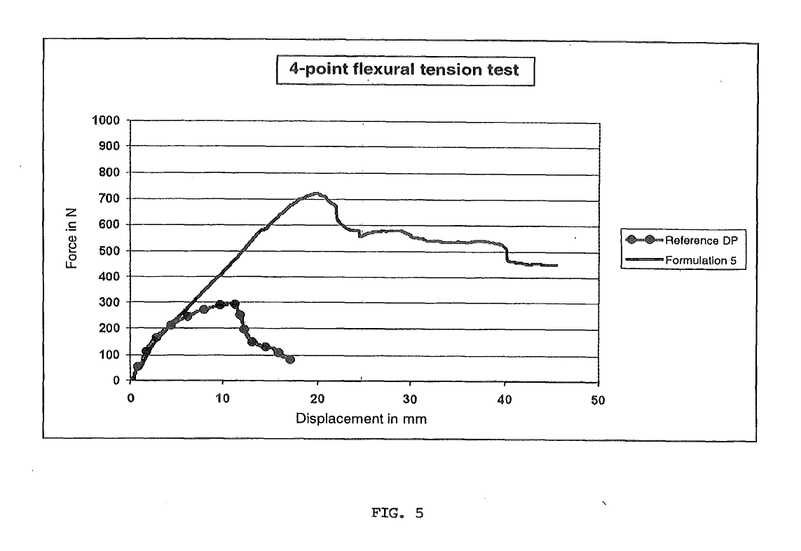

The test set-up and the specimen 10 are shown in FIG. 4.

The reinforcing fibers 12 were introduced into the specimens 10 uncoated in one set of tests and, in a second set of tests, were coated with polychloroprene formulation no. 5 as described above (Table C). Five specimens 10 were tested in each set of experiments. FIG. 5 (results of flexural tension tests of specimens with reinforcement coated with polychloroprene and uncoated (reference DP)) shows characteristic traces of curves for one sample from each set. On the diagram, the flexural tensile force is plotted via the transverse displacement.

The upper curve refers to a specimen with polychloroprene coated reinforcement, the lower to an uncoated reference sample. A clear improvement in mechanical properties of the component due to coating can be seen, as given in the list below:
Increase in maximum flexural tension force;
Increase in deflection at maximum flexural tension force;
Increase in maximum deflection;
Magnification of the amount of energy uptake or work done during the test, this being characterized by the size of the area under the curve.

This type of tough fracture behavior is a recognized feature demonstrating the suitability of a material for constructions that are subjected to high dynamic stresses. In the construction industry, this relates in particular to high dynamic stresses arising as a result of e.g. earthquakes, vehicle impacts, bombardment or explosion pressure waves.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for preparing a concrete-reinforcing fiber comprising soaking the fiber in an aqueous mixture containing
a) a polychloroprene dispersion with an average particle size of 60 to 220 nm,
b) an aqueous dispersion of inorganic solids, with a primary particle size of 1 to 400 nm.
c) optionally, polymer dispersions other than the polychlorprene dispersion (a), the polymer dispersions based on compounds selected from the group consisting of polyacrylate, polyacetate, polyurethane, polyurea, rubber and epoxide, and
d) optionally, additives conventionally used in polymer dispersions.

2. The process according to claim 1, wherein more than 20% of the solids in suspensibn (b) consist of silicon dioxide.

3. The process according to claim 2, wherein the solids in suspension (b) contain silanol groups.

4. The process according to claim 2, wherein the primary particle size of the silicon dioxide is between 8 and 50 nm.

5. The process according to claim 1, wherein 0.1 to 1.5 mol-% of the chlorine atoms of the polychloroprene are replaced by hydroxide groups.

6. The process according to claim 1, wherein the mixture contains up to 10 wt. % of zinc oxide.

7. The process according to claim 1, wherein the mixture has a concentration of dispersed polymer of 30 to 60 wt. %.

8. The process according to claim 1, wherein the mixture comprises from 20 to 99 wt. % polychloroprene dispersion (a) and from 1 to 80 wt. % dispersion of inorganic solids (b), the percentages are based on the weight of non-volatile components, and the percentages add up to 100%.

9. The process according to claim 1, further comprising removing at least part of the water at temperatures between 20° C. and 220° C.

10. The process according to claim 9, further comprising crosslinking the mixture.

11. Concrete-reinforcing fiber produced according to the process of claim 1.

12. A concrete structure reinforced with fiber produced according to the process of claim 1.

13. A concrete structure according to claim 12, wherein the structure is selected from the group consisting of bullet-resistant facade elements, strong-room walls, bunker walls, amour-plating and armor-plated elements on military vehicles, gun turrets, coverings and barriers against rock falls and avalanches, crash-barriers, anti-impact elements, bridges and bridge elements, earthquake-safe buildings or parts of buildings, doors and door elements, safety doors, protected area doors, bunker doors, pylons, roofs and roofing elements.
